(19) United States
(12) Patent Application Publication
(10) Pub. No.: US 2014/0320412 A1
(43) Pub. Date: Oct. 30, 2014

(54) Sliding Keyboard for Electronic Device

(71) Applicant: Geoffrey P. Champion, South Plainfield, NJ (US)

(72) Inventor: Geoffrey P. Champion, South Plainfield, NJ (US)

(21) Appl. No.: 14/264,434

(22) Filed: Apr. 29, 2014

Related U.S. Application Data
(60) Provisional application No. 61/816,841, filed on Apr. 29, 2013.

(51) Int. Cl. G06F 3/02; H01H 13/84

(52) U.S. Cl. CPC G06F 3/0216; H01H 13/84; H01H 2217/00
USPC 345/168; 200/5 A

(57) ABSTRACT

The present disclosure describes and teaches a keyboard for use with an electronic device. The keyboard may be detachable from the electronic device or integrated with the electronic device. The keyboard has a number of bases which support the various keyboard keys. These bases are on a rail system that allows them to be placed in a storage position or placed in a functional position. The keys of the keyboard may have a number of configurations and have either physical or virtual keys.

### CLAIM OF PRIORITY

This application claims priority to U.S. Application Ser. No. 61/816,841 filed on Apr. 29, 2013, the contents of which are herein fully incorporated by reference in its entirety.

### FIELD OF THE EMBODIMENTS

This invention and its embodiments relates to portable electronic devices, namely portable electronic devices having multiple operable configurations. In particular, the field relates to portable electronic devices having fully functioning, slidable keyboard(s).

### BACKGROUND OF THE EMBODIMENTS

The rise in the prevalence of electronic devices, such as smart phones at tablets, has been met with a number of these devices having multiple applications and being capable of performing a number of functions. These devices, at their core, are often very similar as they have common features such as visual displays, programmable processors, and memory. Depending on the particular electronic device, the manner of interaction may vary. For example, smart phones typically have a touch screen interface with virtual keys that relay on capacitive touch screen technology. Many tablets, such as the iPad®, bear similar functionality. However, most lap top and desktop computers have a physical keyboard for the inputting of information. Further, some cellular phones also use physical keyboards. In a lap top or desktop computer, the keyboard is preferential due to screen sizes and the size of the keyboard. The keyboard is also configured in a way that is comfortable and aids in the rapid input of information into the respective device.

However, the physical or virtual keyboards used in many touch screen devices, especially cellular phones, are of a size and configuration that is not conducive for typing. These keyboards are small and lack a typical complete keyboard layout, preventing one from using all of the fingers to type. Additionally, these keyboards often lack otherwise readily accessible keys thus requiring a user to change keyboard screens in order to find the appropriate symbol, number, or punctuation. If a more expansive keyboard is used, the size of the keyboard becomes cumbersome and unsightly. In addition, the keyboard cannot easily be concealed which then results in an undesirable electronic device.

Therefore, there is a need for a fully functional keyboard to be used with any number of electronic devices. The keyboard should be of an appropriate size and bear substantial functionality so as not to be a hindrance to those who wish to use it. Even still, the keyboard must be compact enough to stow away efficiently and taking up minimal space when not in use. The present invention and its various embodiments meets and exceeds these objectives.

As such, various devices are known in the art. However, their structure and means of operation are substantially different from the present disclosure. The existing keyboards are small and lacking sufficient functionality. The other inventions also fail to solve all the problems taught by the present disclosure. The present invention provides for a keyboard that can enable the rapid input of information into an electronic device and then be stored compactly when not in use. At least one embodiment of this invention is presented in the drawings below and will be described in more detail herein.

### SUMMARY OF THE EMBODIMENTS

An embodiment of the present invention provides for a data entry and communication system having a slidable keyboard with a left keyboard base having a plurality of left keyboard keys, wherein the left keyboard base is slidably coupled to a lower glide rail, a right keyboard base having a plurality of right keyboard keys, wherein the left keyboard base is slidably coupled to an upper glide rail, and a number pad base having a plurality of number keys; and an electronic device with a visual display having a keyboard housing, wherein the lower glide rail and the upper glide rail are coupled to the housing.

In another embodiment of the present invention there is a keyboard for use with an electronic device having a left keyboard base having a plurality of left keyboard keys, wherein the left keyboard base is slidably coupled to a lower glide rail; a right keyboard base having a plurality of right keyboard keys, wherein the right keyboard base is slidably coupled to an upper glide rail; a number pad base having a plurality of number keys, wherein the number pad base is hingeably coupled to the right keyboard base; and a housing coupled to the electronic device, wherein the housing supports the lower glide rail and the upper glide rail and houses at least the left keyboard base and the right keyboard base therein.

Generally, the present invention and its embodiments provide for a keyboard for use with an electronic device that when stored allows an item to function as a typical cellular phone or tablet or the like. In a second, functional configuration, the keyboard turns the aforementioned electronic device into a personal computer with a fully functioning and appropriately sized keyboard. The keyboard slides out along glide rails from its stored position in the housing. The keyboard preferably has a left base and a right base that slide out to the left and right sides respectively of the electronic device. The visual display of the device remains in between the two keyboard bases giving one the ability to type on either side of the visual display while looking at the visual display. The keyboard may slide out horizontally, vertically, or both depending on the exact specification of the device. The keyboard further has a numerical base with number keys that is preferably hingeably connected, or coupled, to the right keyboard base. However, the numerical pad may be coupled to the left keyboard base as well.

In general, the present invention succeeds in conferring the following, and others not mentioned, benefits and objectives.

It is an object of the present invention to provide an electronic device that has a keyboard with a functional position and a storage position.

It is an object of the present invention to provide a keyboard for an electronic device that gives the device cross-platform functionality.

It is an object of the present invention to provide an electronic device that has an efficient and responsive keyboard.

It is an object of the present invention to provide a keyboard for use with an electronic device that is covered and/or protected when not in use.

It is an object of the present invention to provide multiple arrangements of keys to suit a particular user's needs.

It is an object of the present invention to provide a keyboard for use with an electronic device that is lightweight.

It is another object of the present invention to provide a keyboard that can be used with a multitude of electronic devices including PCs, PDAs, tablets, gaming devices, cellular phones, and the like.

It is another object of the present invention to provide a keyboard that is either permanently or removably coupled to the electronic device.

### BRIEF DESCRIPTION OF THE DRAWINGS

FIG. 1 is a sectional side view of a preferred embodiment of the present invention in a closed, storage configuration.

FIG. 2 is a sectional side view of a preferred embodiment of the present invention in a transition configuration.

FIG. 3 is a sectional side view of a preferred embodiment of the present invention in an open, functional configuration.

### DESCRIPTION OF THE PREFERRED EMBODIMENTS

The preferred embodiments of the present invention will now be described with reference to the drawings. Identical elements in the various figures are identified with the same reference numerals. Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

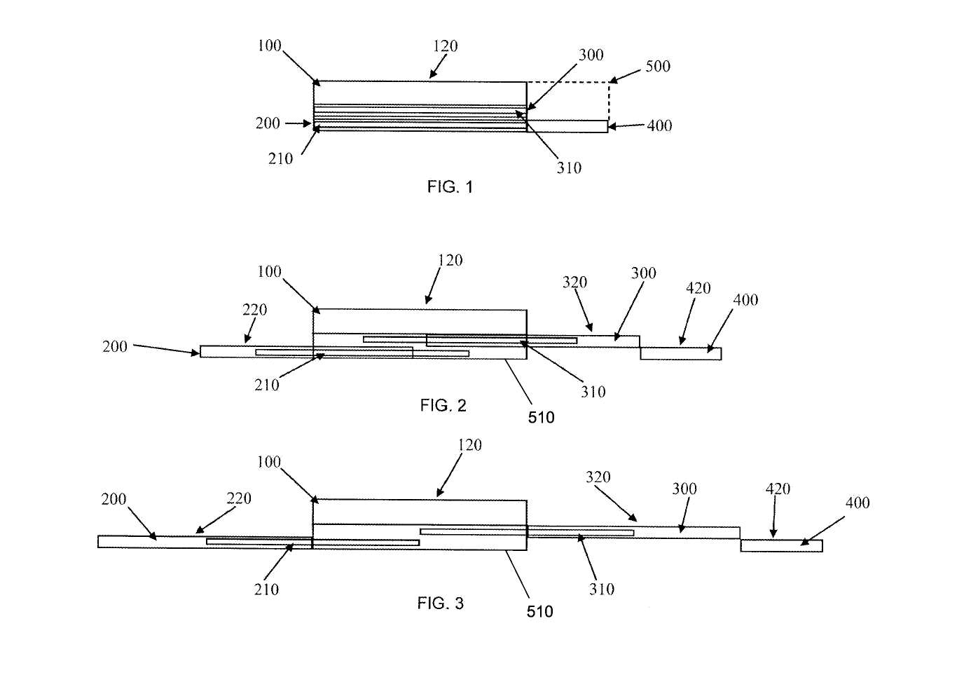

Referring now to FIG. 1, shown is a sectional side view of a preferred embodiment of the present invention. The electronic device 100 has a housing 510 (see FIG. 2) attached thereto. The electronic device 100 is preferably portable and has a visual display 120. The visual display 120 may be any type of display including, but not limited to, varying types of liquid crystal displays (LCDs) and light emitting diode (LED) displays. The visual display 120 may also combine display types such as having an LED backlit LCD display. Preferably, the visual display 120 is touch sensitive. Touch sensitive displays may possess those qualities known in the art including haptic feedback mechanisms.

The keyboard comprises primarily a left keyboard base 200 and a right keyboard base 300. In some embodiments, the keyboard further comprises a number pad base 400. The number pad base 400 may be attached to either the left keyboard base 200 or the right keyboard base 300. The number pad base 400 may be hingeably connected to either of the keyboard bases. In some instances, there is a covering 500 which serves to protect a number pad base 400. The covering 500 may be any suitable material to prevent damage to the number pad base 400 including metals, plastics, rubbers, textiles, composites, and the like or any combination thereof.

Depending on the configuration of the covering 500, the number pad base 400 may be positioned so that only that component is visible. Thus, the number pad base 400 could be hingeably coupled to the keyboard bases, and when positioned in an open position extends past the cover 500. Additionally, the number pad base 400 may be slid out so that only the number pad base 400 is usable. Each of the left keyboard base 200 and right keyboard base 300 are slidably coupled to a lower glide rail 210 and an upper glide rail 310 respectively.

In FIG. 2 the keyboard is shown in a transition state wherein it is neither fully in the storage position nor in the functional position. This sectional side view demonstrates the interaction between the keyboard bases 200,300, glide rails 210, 310, and housing 510.

Here, the electronic device 100 with a visual display 120 is attached or coupled to a housing 510. The housing 510 may be permanently or removably coupled to the electronic device 100. Such removable coupling mechanisms may include, but are not limited to, hook and loop fasteners, snaps, latches, locks, and the like, or any combination thereof. If the housing 510 can readily be attached or detached from the electronic device 100, it may be preferable to include a wireless transceiver with either of the keyboard bases 200, 300 that prevents the need for wired connections to the electronic device 100.

Alternatively, wired connections can be used to connect to the electronic device 100 using any number of suitable connection mechanisms such as a universal serial bus (USB) port connector. The housing 510 preferably has a basal section and two substantially vertical sections forming a general “U” shape. The basal section provides protection for the keyboard bases 200, 300 from suffering damage when being struck, jarred, or impacted from below. The two substantially vertical sections connect the basal section to the electronic device 100. Further these sections provide a surface area for the glide rails 210, 310 to be secured. The vertical sections further provide protection from side impacts. In some embodiments, there may be additional panels hingeably coupled to the basal section. This may allow for complete enclosure of the keyboard bases 200, 300 when the bases 200, 300 are not in use. When the keyboard is desired to be used, the hinged sections are simply flipped down and the bases 200, 300 slid outwards in to the functional position.

With the keyboard bases 200, 300 exposed, it is apparent that the left keyboard base 200 has a plurality of left keyboard keys 220 and the right keyboard base 300 has a plurality of right keyboard keys 320. Further, the number pad base 400 has a plurality of number keys 420. Each of the left keyboard base 200 and the right keyboard base 300 are slidably coupled to a lower glide rail 210 and an upper glide rail 310 respectively. In order to put the keyboard bases 200, 300 in a functional position, the user takes each of the left keyboard base 200 and the number pad base 400 and pulls the bases 200, 400 laterally outwards from the electronic device 100. This enables the left and right keyboard bases 200, 300 to slide along the glide rails 210, 310 putting them in an outward or functional position as shown in FIG. 3. Each of the left and right keyboard bases 200, 300 are slidable independent of the other base.

In FIG. 3 a sectional side view of a preferred embodiment of the present invention is shown with the keyboard bases 200, 300 in a fully extended functional position. As such, each of the left keyboard keys 220, right keyboard keys 320, and number pad keys 420 are fully exposed. The user can now type using the keyboards positioned on either side of the electronic device 100. The visual display 120 is positioned central to the user's vision in order to provide an unobstructed view as to the data input stemming from the keyboard keys 220, 320.

The lower glide rail 210 and the upper glide rail 310, still support the keyboard bases 200, 300 in this configuration. It may be preferable to have stops or blocking mechanisms which prevent the keyboard bases 200, 300 from being completely withdrawn from the housing 510. Once in position, the keyboard bases 200, 300 may be able to be locked in position to prevent undesirable movement of the keyboard bases 200, 300 while the user is attempting to type. In this configuration, any of the electronic devices 100 can operate as a fully functioning PC type device with a full keyboard. The glide rails 210, 310 are preferably shaped to interact with a groove or shape present on the keyboard bases 200, 300. This interaction can take a number of forms and include shaped channels and extensions that are complementary to one another. Further, bearings may be used in conjunction with the glide rails 210, 310 to facilitate a smooth, and consistent movement when the keyboard bases 200, 300 are slid outwards and inwards.

The keyboard and keyboard bases, as shown and described in FIGS. 1-3 may have any number of keyboard key layouts. Preferably, the layout would be that of the “QWERTY” conventional layout. However, depending on the region or country in which an embodiment of the invention as used, the layout of the keyboard may need to change. Additionally, the keyboard keys 220, 320 should be divided between the left keyboard base 200 and the right keyboard base 300 within the guidelines for general typing principles.

Thus, the left keyboard base 200 using a conventional “QWERTY” layout should comprise the letters “t,” “g,” and “b” and those to the left of those keys. The right keyboard keys 320 should comprise the letters “y,” “h,” and “n” as well as those the right of these letters. Any modifying, punctuation, editing, navigation, etc. keys should be assigned to the respective keyboard base on which they would normally appear. It may be proper to have some such keys appear on both the left keyboard base 200 and the right keyboard base 300. The keys appearing on the keyboard preferably form a set of keys (i.e. all necessary alpha characters or all numerical keys) including character keys (i.e. a, f, g, t, etc.), editing keys (i.e. return/enter, backspace), modifier keys (i.e. shift, control, etc.), system keys (i.e. escape, print screen), navigation keys (i.e. arrow keys, page up, page down, etc.), function keys (i.e. F1, F3, etc.) numeric keys (i.e. 1, 2, 3, etc.), and lock keys (i.e. caps lock, scroll lock) or any combination thereof.

Additionally, the left keyboard keys 220, right keyboard keys 320, and the number pad keys 420 may be physical keys or virtual keys. Physical keys are defined tangible keys that rely on a depression of the keys to send a signal to the processor. Virtual keys are visual representations of keys on a touch responsive screen. The keyboards with physical keys may take on the traditional look and feel of a keyboard, whereas the virtual keyboard would be comparable to the smaller touch responsive keyboard on, for example, smart phones.

Each of the left keyboard base 200 and the right keyboard base 300 may be approximately the diameter of the electronic device 100 along which the keyboards are slidable. For example, if a smart phone is generally rectangular shaped, the keyboard bases 200, 300 may be positioned and sized to be used along the length or the width of the electronic device 100. It may be preferably in such a scenario that the keyboard bases 200, 300 are positioned along the longer of the length and width. This would enable each of the keyboard bases 200, 300 to be the largest size (i.e. approximately equal in size to the larger of the width and length) and provide for a preferable orientation of the visual display 120. Hence, the sizing of the keyboard bases 200, 300 will vary depending on the placement of the number pad base 400 and the size of the electronic device 100 with each of the keyboard bases 200, 300 being approximately at least as long as one side of the electronic device 100.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A data entry and communication system comprising:
a slidable keyboard comprising,
a left keyboard base having a plurality of left keyboard keys,
wherein the left keyboard base is slidably coupled to a lower glide rail,
a right keyboard base having a plurality of right keyboard keys,
wherein the right keyboard base is slidably coupled to an upper glide rail, and
a number pad base having a plurality of number keys; and
an electronic device with a visual display having a keyboard housing,
wherein the lower glide rail and the upper glide rail are coupled to the housing.

2. The system of claim 1 further comprising a covering.

3. The system of claim 2 wherein the covering shields and protects the number pad base and number keys.

4. The system of claim 3 wherein the number pad base is hingably coupled to the right keyboard base or the left keyboard base.

5. The system of claim 1 wherein the housing is removably coupled to the electronic device.

6. The system of claim 1 wherein the housing is integrated into the electronic device.

7. The system of claim 5 wherein the keyboard has a wireless transceiver capable of communicating with the electronic device.

8. The system of claim 1 wherein the electronic device is a PDA, laptop computer, desktop computer, smart phone, gaming system, alarm system, thermostat, or any combination thereof.

9. A keyboard for use with a portable electronic device, the keyboard comprising:
a left keyboard base having a plurality of left keyboard keys,
wherein the left keyboard base is slidably coupled to a lower glide rail;
a right keyboard base having a plurality of right keyboard keys,
wherein the right keyboard base is slidably coupled to an upper glide rail; and
a number pad base having a plurality of number keys,
wherein the number pad base is hingeably coupled to the right keyboard base.

10. The keyboard of claim 9 wherein the left keyboard keys, right keyboard keys, and number keys are physical or virtual keys.

11. The keyboard of claim 10 wherein the virtual keys are touch sensitive keys.

12. The keyboard of claim 9 wherein the left keyboard base and right keyboard base are slidable independent of one another.

13. The keyboard of claim 9 wherein the left keyboard base, right keyboard base, and number key base collectively contain at least one set of character keys, editing keys, modifier keys, system keys, navigation keys, function keys, numeric keys, and lock keys, or any combination thereof.

14. The keyboard of claim 9 further comprising a housing,
wherein the lower glide rail and the upper glide rail are secured to the housing.

15. The keyboard of claim 14 wherein the housing is removably or permanently coupled to the electronic device.

16. A keyboard for use with a portable electronic device, the keyboard comprising:
a left keyboard base having a plurality of left keyboard keys,
wherein the left keyboard base is slidably coupled to a lower glide rail;
a right keyboard base having a plurality of right keyboard keys,
wherein the right keyboard base is slidably coupled to an upper glide rail;
a number pad base having a plurality of number keys,
wherein the number pad base is hingeably coupled to the right keyboard base; and
a housing coupled to the electronic device,
wherein the housing supports the lower glide rail and the upper glide rail and houses at least the left keyboard base and the right keyboard base therein.

17. The keyboard of claim 16 further comprising a covering,
wherein the covering covers and shields at least the number pad base and plurality of number keys.

18. The keyboard of claim 16 wherein the upper glide rail and the lower glide rail provide for horizontal or vertical movement of the keyboard bases.
